(19) United States
(12) Patent Application Publication
(10) Pub. No.: US 2005/0243729 A1
(43) Pub. Date: Nov. 3, 2005

(54) Method and apparatus for automating and scaling active probing-based IP network performance monitoring and diagnosis

(75) Inventors: Loki M. Jorgenson, Vancouver (CA); Robert C. Norris, Vancouver (CA)

Correspondence Address: PERKINS COIE LLP;PATENT-SEA, P.O. BOX 1247, SEATTLE, WA, 98111-1247, US

(73) Assignee: Apparent Networks, Inc., Vancouver (CA)

(21) Appl. No.: 11/107,400

(22) Filed: Apr. 15, 2005

Related U.S. Application Data
(60) Provisional application No. 60/562,547, filed on Apr. 16, 2004.

(51) Int. Cl. H04L 12/26

(52) U.S. Cl. 370/241; 370/235

(57) ABSTRACT

The present invention provides a method an apparatus for adaptively refining the sampling within an IP network performance monitoring and diagnosis framework. This ability to adaptively adjust the resolution of the sampling can enable variable accuracy and detail in the related IP network analysis. The sampling resolution can be defined as, for example, the load on the network in terms of the rate of packet transmission, the statistical variance thereof and the complexity of the sampling procedure. Each sampling and analysis procedure determines one or more network parameters referred to as critical indicators. Decisions for subsequent samplings and actions are made based on the determination of these critical indicators. As such various evaluation activity levels are defined by conditions that can be checked for and detected within the context of that activity level. A feedback/feedforward process can be used to enhance the resolution of subsequent samplings, for example movement to a more detailed activity level, if the need is required. In addition, the present invention can support activities such as automated remediation wherein problems in a given IP network path that are identified during the sampling and diagnostic evaluation thereof are subsequently resolved by making changes in the path. The present invention can automate and enhance the monitoring, diagnosis and remediation processes, thereby reducing human involvement until human intervention may be required. In addition, the automatic functionality inherent within the present invention can enable the sampling to be scalable and responsive to changes in IP network conditions as they arise.

### RELATED APPLICATIONS

This non-provisional application claims the benefit of U.S. Provisional Application No. 60/562,547, filed Apr. 16, 2004, which is incorporated herein by reference in its entirety.

### FIELD OF THE INVENTION

The present invention pertains to the field of IP networks and in particular to a method and apparatus for automating and scaling active probing-based IP network performance monitoring and diagnosis.

### BACKGROUND

In packet-based networks, it is often desired to test communications between two specific nodes on the network. This can generally be affected from a first one of the nodes by requesting the other node to perform a function of “looping-back” a test packet sent from the first node. The first node, on receiving back the test packet from the other node, can thereby ascertain not only that communication is possible with the other node, but also the round trip time for the packet therebetween.

More complex characteristics of the transmission path are also ascertainable as disclosed in U.S. Pat. No. 5,477,531. In this patent a predetermined sequence of test packets is transmitted from one node to another and the effect of the network on the sequence as a whole is observed. For example, by varying packet size in sequences of packets to be transmitted, characteristics such as bandwidth, propagation delay, queuing delay and the network's internal maximum packet size can be derived. In addition, buffering and re-sequencing characteristics of the network can also be determined.

Similarly, U.S. patent application No. 20020080726 provides a means for evaluating a communications network by selectively sending a plurality of network evaluation signals, or probative test packets, through the network. Based on the networks response to these probative test packets, network evaluation parameters are determined. For example, response time and throughput characteristics, including streaming utilization of the network, are determined.

In addition, systems that enable test packets to be placed onto a network in a precise fashion also exist such as that disclosed in U.S. patent application No. 20030117959. In this patent application a test packet sequencer is described wherein this sequencer can dispatch test packets onto a computer network, wherein a computer running software under an operating system enables the packet dispatching. The software uses I/O completion ports to dispatch packets and bursts of packets, which may be dispatched to travel a path in the network that can terminate at the test packet sequencer. In this scenario, the test packet sequencer may also receive and time stamp returning packets and bursts of packets.

For diagnosis of network problems, U.S. patent application No. 20030103461 provides a system for defining signatures from collected test data forming a test signature and subsequently comparing this test signature to existing predetermined signatures corresponding to various network conditions. The system can thus identify one or more of the predetermined signatures that match the test signature and may identify a predetermined signature that the test signature best matches, thereby providing a means for establishing one or more network conditions that may be present as represented by the test signature. The systems described above rely on generic sampling that can scale in density and typically require correlation of a number of different samples. These systems enable sampling over network paths and diagnosis of network problems, however, generally once diagnosis has been performed human intervention is required to remediate the problem or affect further types of tests to identify the problem more precisely, if required. This form of process therefore is a reactive type process as no further processes may be initiated prior to external intervention. Thus, highly trained personnel are required for troubleshooting and problem resolution once a potential problem has been identified, which can be both expensive and time consuming.

“Intelligent probing: A cost-effective approach to fault diagnosis in computer networks” by M. Brodie, I. Rish and S. Ma and similarly “Active Probing” by M. Brodie, I. Rish, S. Ma, G. Grabamik and N. Odintsova, I.B.M. T. J. Watson Research, define a form of event correlation using a dynamic Bayesian network approach and a method for robustly determining from many noisy Boolean inputs, or “probes” which events indicate a fault. The method defines an optimal approach such that the minimum number of probes is used to limit load on the network and support scalability. This method assumes a Boolean/binary sampling, such as when checking for connectivity, which is typical for many types of devices and sampling. The concept of hierarchy of active probing sampling and analysis is also defined in this method and relies on a range of mechanisms such as ICMP Echo or ping responses at well-known service ports, for example SMTP, HTTP, FTP, DNS and LDAP. In addition, this method suggests a process of problem determination that evolves on the basis of a dependency matrix, for example probe and response correlation, and seeks to optimize the process to be a minimum set of probes. The hierarchy is defined in terms of layers, including the network layer, hardware layer, system layer, application layer and component/module layer. At any resolution, however, this approach is limited to the number of probes that it sends and does not support increasing detail in the diagnosis, only increasing accuracy in the detection and localization of potential problems.

Therefore, there is a clear need for a system that is able to adequately identify problems, adjust testing parameters to resolve the nature and location of network problems and to remediate these problems, while requiring reduced levels of human intervention and fewer personnel with high levels of training to perform the desired tasks.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for automating and scaling active probing-based IP network performance monitoring and diagnosis. In accordance with an aspect of the present invention, there is provided a method for automating and scaling active probing-based IP network performance monitoring and diagnostics of a network path between a first node and second node, said method comprising the steps of: receiving a trigger initiating a predetermined network test having a predetermined resolution level; performing the predetermined network test, said predetermined network test including transmitting one or more packets between the first node and the second node and collecting information relating to transmission characteristics of the one or more packets; determining one or more critical indicators based on the transmission characteristics of the one or more packets; evaluating the one or more critical indicators with a predetermined set of criteria associated with the predetermined resolution level and determining a subsequent network test based thereon, said subsequent network test having the predetermined resolution level or an alternate resolution level; and performing the subsequent network test.

In accordance with another aspect of the invention, there is provided apparatus for automating and scaling active probing-based IP network performance monitoring and diagnostics of a network path between a first node and second node, said apparatus comprising: an input for receiving a trigger initiating a predetermined network test having a predetermined resolution level; a sampling mechanism for performing the predetermined network test, said predetermined network test including transmitting one or more IP packets between the first node and the second node and collecting information relating to transmission characteristics of the one or more IP packets; and an analysis system for determining one or more critical indicators based on the transmission characteristics of the one or more IP packets, said analysis system further for evaluating the one or more critical indicators with a predetermined set of criteria associated with the predetermined resolution level and determining a subsequent network test based thereon, said subsequent network test having the predetermined resolution level or an alternate resolution level.

In accordance with another aspect of the invention, there is provided computer program product comprising a computer readable medium carrying a set of computer-readable signals including instructions which, when executed by a computer processor, cause the computer processor to execute a method for automating and scaling active probing-based IP network performance monitoring and diagnostics of a network path between a first node and second node, said method comprising the steps of: receiving a trigger initiating a predetermined network test having a predetermined resolution level; performing the predetermined network test, said predetermined network test including transmitting one or more IP packets between the first node and the second node and collecting information relating to transmission characteristics of the one or more IP packets; determining one or more critical indicators based on the transmission characteristics of the one or more IP packets; evaluating the one or more critical indicators with a predetermined set of criteria associated with the predetermined resolution level and determining a subsequent network test based thereon, said subsequent network test having the predetermined resolution level or an alternate resolution level; and performing the subsequent network test.

### BRIEF DESCRIPTION OF THE FIGURES

FIG. 1 is a schematic view of the hierarchy of resolution levels and their interconnectivity according to one embodiment of the present invention.

FIG. 2 illustrates a plot of mean time for samplings according to one embodiment of the present invention.

FIG. 3 illustrates a flow diagram of chainable responses according to one embodiment of the present invention.

FIG. 4 illustrates a flow diagram of the structure and flow of the trigger/action framework according to one embodiment of the present invention.

FIG. 5 illustrates a flow diagram for an example of operation of one embodiment of the present invention.

### DETAILED DESCRIPTION OF THE INVENTION

Definitions

The term “layer 3” is used to define the network layer of a communication model which provides routing information, addressing and other related services enabling the transmission of information over an IP network. For example in a commonly referenced multilayered communication model termed Open Systems Interconnection (OSI), layer 3 is concerned with, for example, knowing the address of the neighbouring nodes in the network, selecting routes, quality of service, and recognizing and forwarding incoming messages from local host domains to the transport layer (layer 4), wherein the transport layer ensures the reliable arrival of messages and provides optional error checking mechanisms and data flow controls. While it may be noted that layer 3 may be specific to a particular protocol, it is assumed that the definition of layer 3 can additionally be used to define a comparable operational layer in any alternate packet communication model.

The term “layer 3 device” is used to define a device that operates on layer 3 of a packet communication model, which may be termed the network layer. A layer 3 device can include for example a router, or other network layer suitable device as would be readily understood by a worker skilled in the art.

The term “packet” is used to define a piece of information that is being transmitted over an IP network. The size of a packet can vary greatly depending on a number of criteria including for example network capacity and size practicality. A packet is a unit of data that is routed between an origin and a destination on the Internet or any other packet-switched network. For example, when a file or other type of information is to be transmitted over a packet switched network, this file can be divided into “chunks” or packets that are of an efficient size for routing within the network.

The terms “resolution level” and “resolution” are used interchangeably to define the detail of a particular level of operation in terms of the sampling and analysis capabilities. Resolution increases may refer to increases in the detail and accuracy of the analysis outcomes, typically requiring a related increase in the amount and complexity of sampling. Resolution can be used to define the variations between distinct testing levels and can define variations of sampling within a particular testing level. For example, a change in resolution can be defined as changing the sampling procedure within a testing level, for example changing test packet protocol or can be defined as changing testing levels, for example changing from a state of normal monitoring to a state of elevated monitoring.

The term “trigger” is used to define an act of initiating an action, wherein a trigger can be provided by a person, machine, program or any other type of trigger type mechanism as would be readily understood by a worker skilled in the art. A trigger can be a start, stop or change type trigger or any other type of trigger as would be readily appreciated.

The term “sequence of packets” is used to define datagrams, bursts or streams of packets. For example, datagrams are single packets transmitted with large inter-packet separations in time. Bursts are groups of a fixed number of packets transmitted with small inter-packet spacing, wherein they are transmitted with large inter-burst separations. Streams are sequences of bursts of fixed size and number transmitted with a fixed separation between the bursts. A sequence of packets can also refer to any other specific set of packets transmitted in a predetermined arrangement.

Unless defined otherwise, all technical and scientific terms used herein have the same meaning as commonly understood by one of ordinary skill in the art to which this invention belongs.

The present invention provides a method and an apparatus for adaptively refining the sampling procedure within an IP network performance monitoring and diagnosis framework. This ability to adaptively adjust the resolution of the sampling procedure can enable variable accuracy and detail in the related IP network analysis. The resolution of the sampling procedure can be defined, for example, as the load on the network in terms of the rate of packet transmission during sampling, the statistical variance thereof, the complexity of the sampling procedure and the type of sampling procedure. Each sampling and analysis procedure determines one or more network parameters referred to as critical indicators. Decisions for subsequent samplings and actions are made based on the determination of these critical indicators. As such various evaluation activity levels are defined by conditions that can be checked for and detected within the context of that activity level. A feedback/feedforward process can be used to enhance the resolution of subsequent sampling procedures, for example movement to a more detailed activity level having a more complex sampling procedure, if the need is required. In addition, the present invention can support activities such as automated remediation wherein problems in a given IP network path that are identified during the sampling procedure and diagnostic evaluation thereof are subsequently resolved by making changes in the path. The present invention can automate and enhance the monitoring, diagnosis and remediation processes, thereby reducing human involvement until human intervention may be required. In addition, the automatic functionality inherent within the present invention can enable the sampling procedure to be scalable and responsive to changes in IP network conditions as they arise.

A sampling procedure comprises the sending and receiving of IP packets, and can be used with the purpose of soliciting a particular response from an IP network being evaluated, which in turn can be utilized to solicit another response therefrom. Responses to sampling transmissions that have some configurable relationship to each other in this manner are referred to as chainable responses. The chainable cycle of the chainable responses and the decision-making capability integrated into the present invention together can define a trigger/action framework. This framework can provide branching between levels of resolution as well as provide an interface for external triggers and terminal or non-responsive actions, such as notifications to be issued. The outcome of each triggered action acts as the trigger to subsequent actions within the framework.

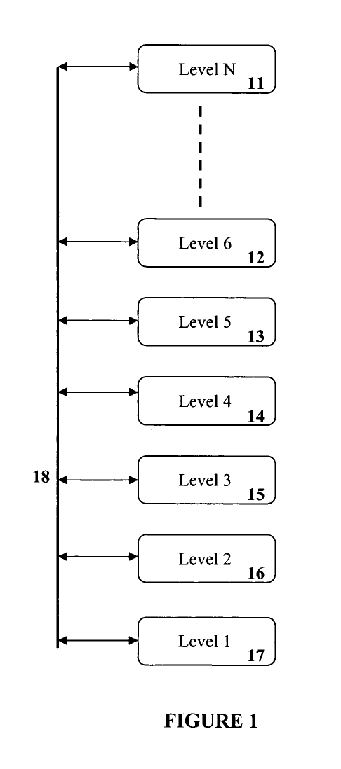

The present invention is schematically represented in FIG. 1, wherein each activity level comprises at least one predetermined sampling resolution for establishing one or more critical indicators. The critical indicators are used to determine via associated chainable responses, if movement to an alternate activity level within the connective framework is required or if an alternate sampling procedure within the same activity level is to be employed. As illustrated all activity levels are interconnected thereby enabling movement therebetween without the need for systematically moving along an activity level ladder. The hierarchy of activity levels can comprise any number of levels and can be determined based on the desired granularity between the activity levels defined between a lowest and highest activity level. For example a coarser resolution between the activity levels can result in a reduced number of distinct activity levels between a lowest and highest activity level and vice versa.

In one embodiment of the present invention a uniform means is provided to enable scaling of a unique active probing mechanism, for example, from a low level monitoring capability that provides coarse resolution on performance and problems, through to mid-level testing that determines measures and minimal diagnostics, to intensive testing that provides more accurate measures and detailed diagnostics, to comprehensive performance analysis that generates a plurality of measures and diagnostics, and may specify remediation actions, if desired.

In one embodiment of the present invention, as the resolution level increases the level of detail of the information collected together with the reliability of the collected information relating to the IP network path also increases, thereby enabling a more sophisticated diagnosis of the path to be performed. For example, the resolution level can reach a level of detail and reliability with respect to a detected problem with the path of the IP network under evaluation that a method of remediation of this detected problem can be determined thereby enabling correction of the detected problem or mitigation of the effect of this detected problem on the IP network.

Network Path

A network path in the context of the present invention can be defined as a path between layer 3 hosts, such as servers or workstations, and all layer 3 devices involved in routing IP packets between them, wherein each layer 3 host and layer 3 device is defined as a node. This definition of a network path can be consistent with a layer 3 view that can be generated by a trace route utility as would be readily understood by a worker skilled in the art. The influence of other elements along the network path, for example media (network traffic), layer 2 devices (such as switches), and other network devices (such as traffic shapers, limiters, filters and firewalls), that are not visible at layer 3, are assumed to be subsumed into the apparent responses of the layer 3 devices collected during a sampling procedure.

For example, for a sampling procedure performed to generate data for use with the present invention, a first network host can assume that typical network mechanisms are present along an IP network path that can generate an acknowledgement from a second network host or other layer 3 device as a result of one or more packets sent by the first network host. Correlation between the sent packets and receipt of the acknowledgement packets can provide a means for defining a network path through the determination of IP network characterizations including, one-way bitrate, one way propagation delay, one way delay variation and one way available bitrate, for example.

For example, connected to the network are one or more mechanisms for sending the ordered groups of packets along a path and receiving the sequences of packets or responses thereto, after they have traversed the path. In one embodiment, sequences of packets originate at a packet sequencer travel along a path to a reflection point and then propagate back to the packet sequencer and in this embodiment the packet sequencer can be positioned at the first network host. In an alternate embodiment a packet sequencer is positioned at the first network host for collecting transmission test data, and another packet sequencer can be positioned at another node for collecting information relating to the reception of the sequences of packets or reception of responses to the originally transmitted sequences packets. A packet sequencer can record information about the times at which packets are dispatched and/or the times at which returning packets are received. A packet sequencer can additionally collect information relating to the type of packets transmitted and the types of packets received, for example. All information collected during the sampling session is considered to be test data.

In addition coupled to the network is an analysis system for receiving the test data and performing a desired analysis thereof, in addition to adaptation or modification of the sampling procedure if required. The analysis system may comprise a programmed computer or may be configured in hardware, or other form of computational system as would be readily understood by a worker skilled in the art. The analysis system may be hosted in a common device or located in a common location with a packet sequencer or alternately may be physically separated therefrom.

In one embodiment of the present invention, the IP network path being evaluated is defined as a path spanning between a first node and second node. For example, during a sampling procedure one or more sequences of packets are transmitted from the first node and addressed to the second node with the collection of information relating to the transmission of the one or more sequences of packets and the collection of the resultant network responses in order to evaluate the IP network path between the first node and second node. This information can comprise timings relating to the transmission of the packets and the receipt of replies thereto. It would be readily understood by a worker skilled in the art that the procedure of evaluation of a path between a first and second node can additionally be complimented by evaluating a path between a first and third node or between a first and fourth node which may encompass portions of the IP network path between the first and second nodes, for example.

As an example, assumed network mechanisms are capable of performing functions including but not limited to: generating an ICMP Echo Reply packet in response to a transmitted Internet Control Message Protocol (ICMP) Echo packet; generating ICMP Timestamp Reply packet in response to a transmitted ICMP Timestamp packet; generating an ICMP Port Unreachable packet in response to a User Datagram Protocol (UDP) packet transmitted to an unassigned port; generating a TCP Reset packet in response to a Transmission Control Protocol (TCP) packet transmitted to an unassigned port; and generating a UDP “echo” packet in response to a UDP packet transmitted to an assigned standard UDP Echo service, port 7. In addition the network mechanisms are assumed to be respondent to a UDP packet transmitted to any assigned port wherein a known service has been installed that responds with a pre-arranged acknowledgement and/or records the arrival of the UDP packet for later analysis; a TCP packet transmitted to any assigned port such that an unknown service, for example a remote agent, software or hardware, generates an Acknowledgement (ACK) or Synchronize (SYN) response according to standard TCP handshake conventions; a TCP packet transmitted to any assigned port wherein a known service, for example a remote agent, software or hardware, has been installed that responds with a pre-arranged acknowledgement and/or records the arrival of the TCP packet for later analysis; a packet of any protocol intended for a specific destination host whose time to live (TTL) has been decremented to 0 such that an intermediate Layer 3 device generates an ICMP TTL Expiry message; a packet of any Layer 3/4 protocol intended for a specific destination host whose size exceeds the maximum transmission unit (MTU) of an intermediate Layer 3 device and has the Don't Fragment (DF) bit set such that it generates an ICMP Fragmentation Required But DF Set message; and generating a response packet from desired node in response to any sampling session packet, including error indications and protocol specific responses.

Sampling Procedure and Sampling Resolution

Sampling refers to the process of sending sequences of packets along a particular network path and observing the outcomes, for example timings, and related responses such as errors. Repeated sampling contributes to a statistical distribution of these observed outcomes that can be attributed to a particular network path between a first node and second node. The statistical distribution of the observed outcomes is representative of, for example, the variables associated with the sequences of packets such as their protocol, number and size, the variables associated with the conditions of the network path between the first node and second node, such as with transient behaviours, and/or the variables associated with the time of sampling such as the period of time over which the sampling is conducted. In addition, the statistical distribution may be qualified with regard to the intended analysis to be performed such as what information or intelligence is to be derived.

The sampling transmissions or sequences of packets, can be characterized in terms of variables such as the number of packets transmitted, the size of each packet, the protocol of each packet, and the relative position of each packet in the sequence of packets transmitted. In addition, the transmissions can be characterized by specific settings within the IP header of a packet, such as the first node, second node and time to live (TTL), and various flags available in the IP header such as type of service (TOS). Typical sampling series include, for example, single packets or datagrams of particular size and protocol, sequences of packets with uniform or varying size and protocol, and combinations of these in varying or fixed order, number or temporal separation.

Sampling resolution can be defined in terms of a hierarchy of sampling levels, with each level representative of, for example, a certain sampling load, complexity and statistical merit. The load of sampling may be represented by the rate of packet transmission over the IP network path, wherein the particular transmission rate would affect the level of resolution. The statistical variance of the outcome of a particular sampling procedure, for example, would also affect the level of sampling resolution required. Similarly, the complexity of an IP network would influence the sampling resolution of a transmission. Although each of these relationships can be interrelated, each of these relationships can provide a basis for evaluating an IP network path at a relevant sampling resolution based on the results thereof. For example, the load on the network can be minimized to achieve a certain objective.

Various analyses are performed on the outcomes of the sampling procedures to determine a number of network responses in terms of specific parameters. Each analysis can be defined in terms of the statistical distributions of acknowledged, and conversely lost, packets that are required. The present invention is multi-tiered in resolution in that there is a hierarchy of sampling and analysis processes, wherein moving through various level of the hierarchy adjusts the resolution. Each level of hierarchy has a particular level of sampling, in terms of, for example, load and complexity associated with it in addition to a particular level of analysis. For example, in one embodiment of the present invention, there are seven levels of hierarchy, namely: inactivity, normal monitoring, elevated monitoring, spot testing, basic testing, full testing, and suite testing.

In one embodiment, in the first level, inactivity, the system may be in a state in which no sampling takes place. An example of sampling that may occur in the second level, normal monitoring is the repeated transmission of a single sample of a series of large packets followed by a waiting period of X seconds. In the third level of elevated monitoring, a set of N samples of a series of large packets may be transmitted, each followed by a waiting period of Y seconds, where Y is less than X. In the next level of the hierarchy, spot testing, a plurality of small sets of repeated samples of a variety of types are transmitted without any wait period. In basic testing, a set of various combined samples of series of various sizes and configurations that constitute a direct test of 30 iterations, for example, may be transmitted. In full testing, the number of iterations may be increased to 100, for example. And lastly, in suite testing, multiple distinct sets of various combined samples of series of various sizes and configurations that constitute multiple full tests of 100 iterations, for example, may be transmitted during sampling. Therefore at each level of resolution a different type of sampling may be affected.

Critical Indicators

Indicators are defined as measurable values, such as temperature in a physical system, or a relationship in terms of variables for example, X≠Y, that can be applied to a decision-making process. According to the present invention, a wide variety of indicators can typically be identified as a result of sampling procedures, some of which can be deemed general and some of which can be unique to a particular type of decision or analysis. Examples of typical indicators for packet transmission over an IP network include the minimum, maximum, mean and standard deviation of the intervals between transmission and acknowledgement of the last packet in a series, the average loss of packets in a series, the mean loss of an entire series, and the rate of change of any of these with respect to time or as a result of the addition of further samples. Since these parameters may be attributed to any sampling distribution, the indicators can be specific to the parameters used to generate the distribution.

Critical indicators are specifically identified indicators that uniquely determine or define high-level states or extrinsic attributions of the sampled distribution. For example, the rate of change (stability) of the mean loss of the entire packet series can act as a critical indicator for the eligibility for analysis of the loss of any inherent patterns. Critical indicators provide the basis for decision-making within each level of the hierarchy. One or more critical indicators may be selected against particular thresholds to define changes in hierarchical state within the hierarchy.

Each level of the hierarchy may have its own critical indicators however all are based on the same root indicators. Root indicators represent a type of characterization determined from the sampling transmission. For example, in one embodiment of the present invention, the root indicators are related to the high level generalization of a network path in terms of network characterizations, for example: intransient characterizations are those which are constant with time, for example end-to-end latency; transient characterizations are those which change over time, for example, available bandwidth; and dysfunctional characterizations are those which are outside the operational parameters of the IP network, for example loss due to media errors.

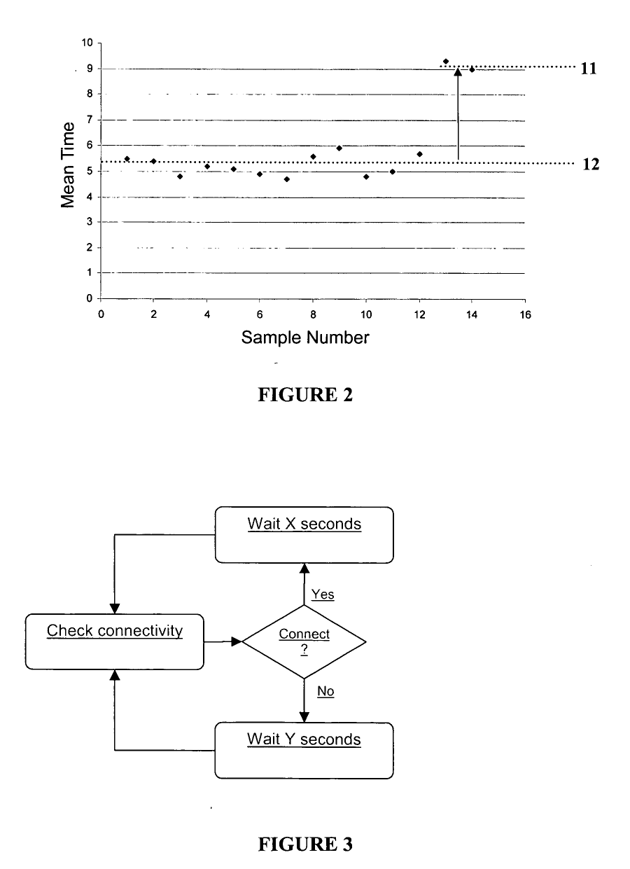

In one embodiment a single critical indicator, termed the root indicator, is associated with each of the above network characterization such that the root indicator can be determined, for example, if a specific distribution of packet timings satisfies a one or more particular constraints relating to one or more of these characterizations. For example, the root indicator for transient characterizations, namely those that vary in time, may be the mean packet timing of one or more of the packets transmitted as a series during a sampling event, for example. In particular, the mean time for a particular packet or sequence of packets to be transmitted and received as measured over multiple sampling events may be the root indicator. FIG. 2 illustrates mean time plotted against sample number for a plurality of sampling events. Over a number of sampling events, the local mean time 11, which is the mean time over a certain set of temporally contiguous events, may be significantly higher (for example, twice as high) than the overall mean time prior to the increase 12. It may also be observed that the overall mean time 12 is changing slowly, commensurate with the contributions from the most recent sampling events. This change in the mean time can signal that the transient characterizations for that IP network path have recently changed overall, wherein this determination can result in the recalculation of a variety of network characteristics for example the re-sampling and re-evaluation of the available bandwidth for the IP network path.

An example of a critical indicator that may be the root indicator for intransient characterizations, namely those that, in general do not vary in time, is the minimum recorded value, or rate of change of the minimum recorded value of the interval between transmission and acknowledgement of the last packet of a series with additional parameterization. This parameterization can be for example consistent packet size and/or protocol used during sampling, while assuming all packets in the series are of equal and maximum path MTU size and all packets in a given series are acknowledged. Another example of a critical indicator that may be the root indicator for intransient characterizations is the mean recorded value, or the rate of change of the mean recorded value, of the interval between transmission and acknowledgement of the last packet with additional parameterization, for example assuming all packets in the series are of equal and maximum path MTU size and all packets in a given series are acknowledged.

An example of a critical indicator that may be the root indicator for dysfunctional characterizations is the mean packet loss, or rate of mean packet loss, for an entire sampling series with additional parameterization that for example there is consistent packet size and/or protocol used during sampling, while assuming all packets in the series are of equal size.

In one embodiment, having particular regard to a critical indicator that is a rate of change, when this type of critical indicator is determined to be within a certain threshold the value determined for that critical indicator can be assumed asymptotic and therefore the associated distribution can be considered static with regard to any measures derived from it.

In one embodiment, critical indicators can be defined outcomes of higher-level analyses such as those associated with pattern matching such as disclosed in U.S. patent application No. 20030103461 herein incorporated by reference. This application provides a system for creating signatures from collected test data forming a test signature and subsequently comparing this test signature to existing sample signatures corresponding to various network conditions. For example, network conditions can be for example, full/half duplex mismatch, half/full duplex mismatch, media errors, congestion, MTU conflict, black, grey or white hole, intermittent connectivity, collision domain violation, rate limiting queue, firewall limiting, router loops or any other network condition as would be readily understood by a worker skilled in the art. The system can thus identify one or more of the example signatures that match the test signature and may identify an example signature that the test signature best matches, thereby providing a means for establishing one or more network conditions that may be present as represented by the test signature. For example, severity levels may be defined in terms of the degree of match and also the weighting associated with the particular pattern. If the derived severity exceeds a particular threshold, subsequent actions may be generated.

In the embodiment wherein there are seven levels of hierarchy, critical indicators may not be associated with the level of inactivity. Examples of critical indicators that may be associated with the normal monitoring and escalated monitoring levels can include the rate of change of the local mean loss of packets relative to the overall mean loss of packets, the rate of change of the local minimum traversal time for the last packet of a sequence of packets relative to the overall minimum traversal time, and the rate of change of the local mean traversal time for the last packet of a sequence of packets relative to the overall mean traversal time. For the basic testing level, examples of critical indicators can include low-resolution diagnostic measures of mean packet loss, bandwidth, latency, network utilization, jitter and test severity. Similarly, these critical indicators may be associated with the full testing level and suite testing level, however, in the case of full testing, each indicator may be evaluated for individual hops within the network path being evaluated and may be specific to a particular diagnostic, and in the case of suite testing the indicators may be evaluated based on various types of diagnostics obtained. It should be noted that the spot testing level of analysis can be used to evaluate all critical indicators with respect to thresholds, that have been determined up to the time of spot testing initiation. Therefore, as the levels of testing increase there are potentially more critical indicators to be evaluated during spot testing.

Chainable Responses

Chainable responses associated with the present invention are a non-trivial set of detectable responses that have a configurable relationship to each other such that the outcome of soliciting or sampling for a specific response from the IP network can be utilized as the basis for soliciting another possible response, including the same response again. This form of configurable relationship may be based on one or more of the aspects of the configuration applied to the solicitation process as well as the measure of the critical indicators associated therewith. For example, as illustrated in FIG. 3, two basic types of action/responses may be “check for connectivity” and “wait”. The binary outcome of “check for connectivity”would be “connected”or “not connected”, and the outcome of “wait X seconds” would be “X seconds waited”. A simple composition of chainable responses based on these outcomes can appear as “if connected, wait X seconds”, “if not connected, wait Y seconds”, and “if finished waiting, check if connected”. With the addition of a means for indicating the current state, this would provide an automated cycle of connectivity checking that may be sped up or slowed down based on whether connectivity was last detected during the cycle.

In one embodiment, responses to particular questions can be composed of other responses. For example, a specific hierarchy of response types that illustrates the composition of responses might be that implemented within an IP network performance system and can comprise those as indicated in Table 1. Table 1 indicates the response types, their associated granularity, examples thereof and typical number of packets sent for that activity level. Having particular regard to the number of packets sent, this characteristic can range within any one level of testing, wherein this characteristic can correspond to a variation in the resolution level within a particular activity level or the type of sampling being performed at the activity level.

TABLE 1

| | | | TYPICAL # |
|---|---|---|---|
| | | | OF |
| RESPONSE | | | PACKETS |
| TYPE | GRANULARITY | EXAMPLE | SENT |
| Command | Most basic unit of | Datagram( ) - Send a single ICMP Echo | 1-50 |
| | response | packet (datagram) and receive Echo Reply | |
| | | packet | |
| Task | Composed of | ICMPConnectivity( ) - Determine ICMP | 5-100 |
| | commands | connectivity of a host by sending a set of 5 | |
| | | independent ICMP Echo datagrams | |
| Stage | Composed of tasks | AllConnectivity( ) - Determine | 15-1000 |
| | | connectivity relative to various protocols | |
| | | such ICMP, UDP and TCP | |
| Test | Composed of stages | DirectTest - Measure and diagnose the | 1000-100,000 |
| | | end-to-end characteristics of a network | |
| | | path | |
| Suite | Composed of tests | ComprehensiveSuite - Measure and | 5000-500,000 |
| | | diagnose the end-to-end path(s) in terms of | |
| | | differing applications, protocols and | |
| | | targets | |

In general, each level of response represents, for example, increasing complexity, time and sampling load with respect to the sampling session performed on the IP network. Each level of response is chainable to another response on the same level. However, it is possible to construct basic responses that effectively permit chaining between levels. As an example, a “Ping” Command is equivalent to sending an ICMP Echo datagram; a “Ping” Task comprises one “Ping” command; a “Ping” Stage comprises one “Ping” task; a “Ping” Test comprises one “Ping” stage and a “Ping” Suite comprises one “Ping” test. In this example, the highest level of response which is the Ping Suite is identical to that which would result from the execution of the lowest level of response being a Ping Command. The inputs to the test, for example a predetermined IP address of a destination host, are transferred down the hierarchy to the command level and the response of the issued command rises through the hierarchy resulting in the test output. This example shows how triggers resulting from a certain level may subsequently initiate activity at other levels.

In the embodiment with seven levels of hierarchy or states, the inactivity level may be a normally terminal state or terminus activity, which may have the chainable response of a “Stop” trigger provided by another state or externally. The inactivity level may alternately be the outcome of not generating a response, for example. The normal monitoring level may have an indefinite state of continuous activity, wherein this response may be initiated by a “Start” trigger provided by another state or externally. The normal monitoring level may be an interrupt or exit from another state, or may result in the triggering of another state, for example escalated monitoring, basic testing or inactivity. Initiation of the normal monitoring level typically requires an IP address of the destination host thereby defining the path under observation, wherein other parameters, for example size, order, temporal separation, of the sequences of the packets to be transmitted may be optional. The elevated monitoring, spot testing, basic testing and full testing levels may have a normally finite state or fixed activity and similarly this response may be initiated by a “Start” trigger provided by another state or externally, and may generate a response causing exit from another state, or may trigger various other hierarchical states as well as a non-responsive activity, for example. These levels of activity would similarly require an IP address of the destination host with other parameters relating to the sampling being optional. In suite testing, this response may be initiated by a “Start” trigger provided by another state or externally, wherein this response may trigger another state including a non-responsive activity, and an IP address would be required, however a series of other responses may also be generated, wherein each of these other responses may result in exit from this activity state.

Trigger/Action Framework

The trigger/action generation framework according to the present invention supports the chaining cycle of the chainable responses and the decision-making capability to define the branching between activity states. In addition the trigger/action framework can provide an interface for external triggers, for example manual initiation of a certain activity state and terminal or non-responsive actions, for example the generation of a notification or alert. The outcome of each triggered action acts as a trigger to one or more subsequent actions including, for example a predefined wait period and/or repetition of the current action. The triggers and actions are defined within a specific framework and may also include undefined triggers and actions that are generated or performed outside the framework. A simple example of an external trigger is the act of a user initiating a process within the framework. Once started, the process may not require any further external trigger to continue although a trigger terminating the process may be appropriate.

The trigger/action framework can support the joining of triggers and actions and the configuration of relationships therebetween. These relationships may comprise one or more triggers, each with its own conditions, leading to one or more actions, each with their own parameters. The relationships can represent expert knowledge of the processes that may lead to the automatic discovery and identification of specific conditions within the IP network, particularly as they may appear over time, without any prior knowledge of their nature or that they might appear at all. The trigger/action framework can support the sampling, data sets, trigger types, analyses, and response definitions associated with the monitoring, analysis and diagnosis of an IP network. In one embodiment of the present invention, the framework can support the defined activity states and their processes, the decision-making processes and their controls, the clocking and event handling, fault recovery and error generation, and I/O to external systems such as notifications, external triggers and the import/export of data.

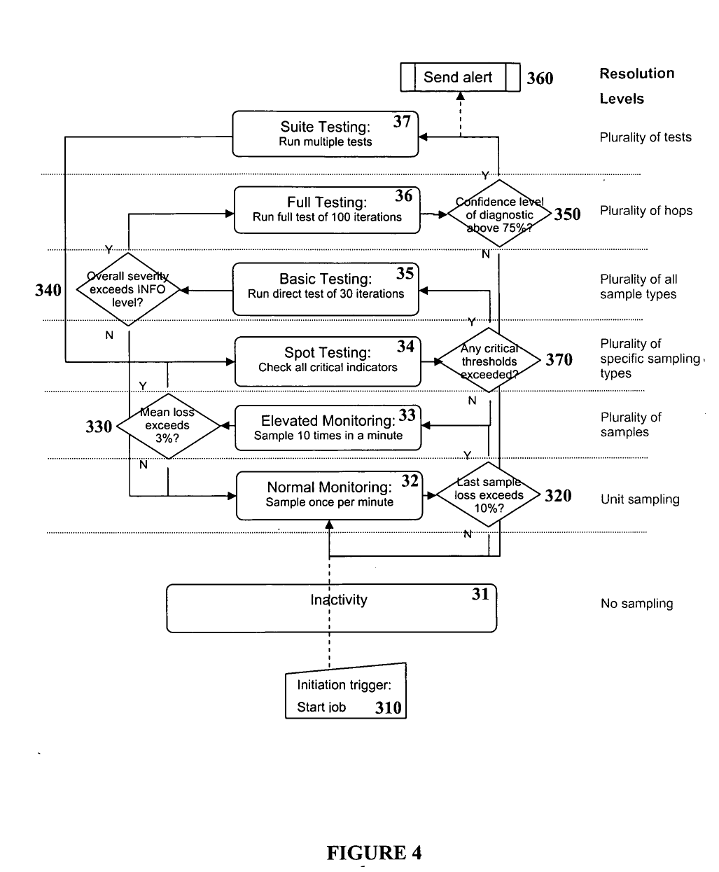

In one embodiment of the present invention, the structure and flow of the trigger/action framework is represented by the flow diagram illustrated in FIG. 4. In this embodiment, seven levels of hierarchy are present, namely, inactivity 31, normal monitoring 32, elevated monitoring 33, spot testing 34, basic testing 35, full testing 36 and suite testing 37.

Assuming the system is initially in a state of inactivity 31, a job can be triggered externally 310, for example by a user, that initiates the normal monitoring 32 state. In this state, sampling can be performed once per minute, for example, and a critical indicator, such as sample loss, can be monitored 320. When this critical indicator exceeds a particular threshold, for example 10%, elevated monitoring 33 can be activated wherein sampling is executed 10 times per minute, for example. Once again a critical indicator, such as mean loss, is monitored 330, and when this critical indicator exceeds a particular threshold, such as 3%, the level of testing is increased to spot testing 34. At this level of activity all the identified critical indicators are evaluated and if any of the critical indicators exceed their respective assigned threshold 370, the level of testing would be elevated to basic testing 35. At this activity level, a plurality of sample types may be used and a direct test can be run for a particular number of iterations, for example 30 iterations. If the overall severity of the problem 340 being tested for increases to a predetermined level the level of testing is escalated to full testing 36. At this activity level, a greater number of iterations, for example 100 iterations, of the same test are run and the confidence level of the diagnostic result monitored 350 can be determined. If the confidence level of the test is above a certain threshold, for example 75%, the testing is further escalated to suite testing 37 and an alert 360 of this diagnostic is generated. This alert can be an external alert sent by the system to a user or can be an internal alert sent to a remediation module associated with the system, for example. During the suite testing 37, a number of critical indicators are determined and these critical indicators are evaluated at the spot testing level 34, wherein the critical indicators are compared to their respective thresholds. When comparison of the critical indicators with their respective thresholds results in an exceeded threshold, the level of testing can once again escalate through the levels of testing, while using the previously collected information for the respective analyses during this escalation of the testing process. Alternately, if all thresholds are not exceeded the testing process de-escalates. As is illustrated in FIG. 4, the evaluation of the selected path of an IP network is constantly being evaluated at any one of a variety of resolution levels until for example a stop trigger is initiated.

The present invention comprises a hierarchy of levels including inactivity and one or more activity levels, wherein each activity level comprises sampling, which constitutes collecting a variety of configurable solicited responses, evaluating critical indicators, which are specific to the sampling types, requiring one or more of each type of critical indicator and chainable responses which constitute a collection of analyses with requisite inputs derived from specific sampling distributions that generate particular outputs that may be used as inputs to other responses. The system further includes a trigger/action framework that supports the connectivity between the chainable responses and various activity levels such that particular outcomes can be achieved, for example automated, continuous and scalable monitoring, diagnosis and remediation of IP networks.

Variations

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as a personal computer, server or the like and pursuant to one or more, or a part of one or more, program elements, modules or objects generated from any programming language, such as C++, Java, Pl/l, or the like. In addition, each step, or a file or object or the like implementing each said step, may be executed by special purpose hardware or a circuit module designed for that purpose.

### EXAMPLE

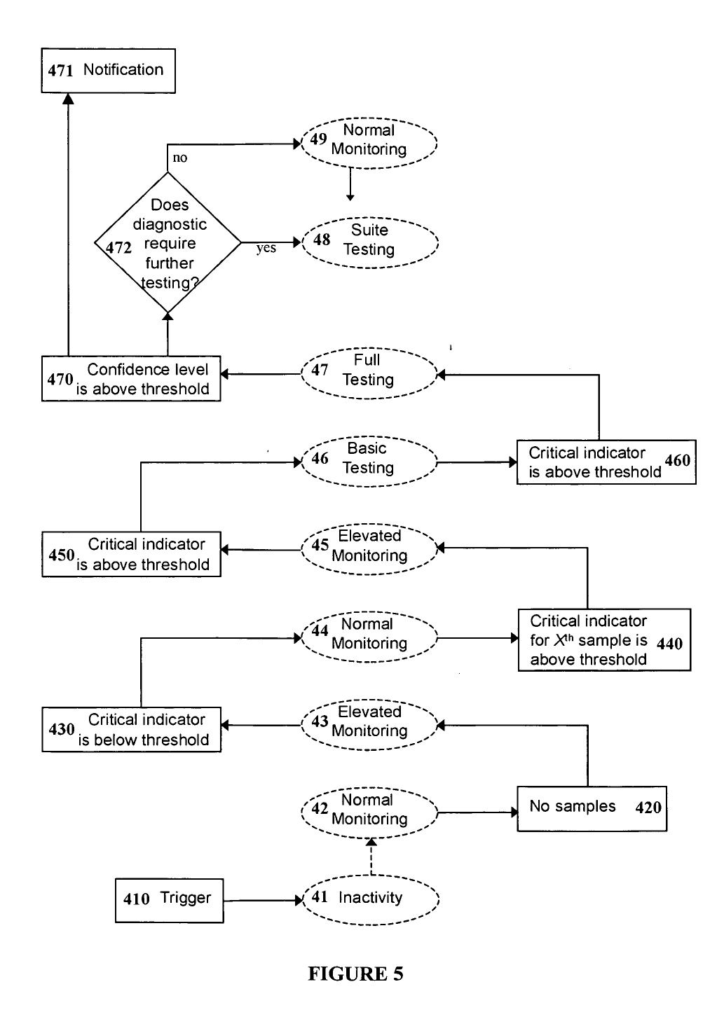

FIG. 5 illustrates a scenario of operation of one embodiment of the present invention. Assuming the system is initially in a state of inactivity 41, a user, management system, or other process, triggers 410 the system to monitor the path between locations defined by a source IP address and a target IP address at an activity level of normal monitoring 42. The system assumes defaults for all levels of activity and begins normal monitoring of the path between the source and the target at a minimum sampling resolution, for example, 1 sample composed of a series of N packets, followed by an analysis, followed by a 60 second wait, which can be repeated indefinitely. Initialization of the system, for example no samples have been transmitted or received 420 qualifies the system to escalate the activity level to elevated monitoring 43 and subsequently checks the status of the network path for future reference, for example connectivity between the source host and target host. At this activity level, the sampling may include transmitting 1 sample comprising a series of N packets, followed by a 6 second wait, repeated 10 times, followed by an analysis. Analysis at the end of the elevated monitoring 43 period subsequently determines that a particular critical indicator is below a threshold 430, and results in the de-escalation of the activity level to normal monitoring 44. Normal monitoring then continues for X samples with the critical indicator remaining below a particular threshold. At the X^{th} sampling session, analysis of the received information indicates that the critical indicator threshold has been exceeded 440 and the system escalates the activity level back to elevated monitoring 45. At the conclusion of elevated monitoring 45, analysis indicates that the critical threshold is exceeded 450 and subsequently escalates the activity level to basic testing 46 without spot testing, since a threshold associated with a particular critical indicator has unambiguously been exceeded. Basic testing then runs an end-to-end test with minimum iterations. This test can be performed without the evaluation of any intermediate path segments along the end-to-end path defined. This analysis determines that the critical indicator exceeds a critical threshold 460 and escalates the system to full testing 47. Analysis of full tests determines that a diagnostic has been generated with a confidence factor or critical indicator that exceeds the critical threshold 470 and the system launches a notification 471 and an alert process that notifies the user/external agent responsible for the monitoring job is performed. Depending on the nature of the diagnostic 472, the system may escalate to suite testing 49 perform a plurality of appropriate types of tests, or the system may de-escalate the activity level back to normal monitoring 49 and continue to sample the network path. While a detectable type of dysfunction remains on the IP network path, the system according to the present invention can repeat this cycle whenever a detectable type of dysfunction appears.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for automating and scaling active probing-based IP network performance monitoring and diagnostics of a network path between a first node and second node, said method comprising the steps of:
a) receiving a trigger initiating a predetermined network test having a predetermined resolution level;
b) performing the predetermined network test, said predetermined network test including transmitting one or more packets between the first node and the second node and collecting information relating to transmission characteristics of the one or more packets;
c) determining one or more critical indicators based on the transmission characteristics of the one or more packets;
d) evaluating the one or more critical indicators with a predetermined set of criteria associated with the predetermined resolution level and determining a subsequent network test based thereon, said subsequent network test having the predetermined resolution level or an alternate resolution level; and
e) performing the subsequent network test.

2. The method according to claim 1, wherein said predetermined resolution level is selected from a plurality of levels of resolution.

3. The method according to claim 2, wherein each of the plurality of levels of resolution is selected from the group comprising: normal monitoring, elevated monitoring, spot testing, basic testing, full testing and suite testing.

4. The method according to claim 1, wherein the one or more packets are configured to generate one or more predetermined responses from the IP network.

5. The method according to claim 4, wherein each of the one or more predetermined responses are selected from the group comprising ICMP Echo Reply packet, ICMP Timestamp Reply packet, ICMP Port Unreachable packet, ICMP TTL Expiry message, ICMP Fragmentation Required But DF Set message, TCP reset packet, UDP echo packet, ACK response and SYN response.

6. The method according to claim 1, wherein the one or more packets are generated using ICMP, UDP or TCP.

7. The method according to claim 6, wherein the one or more packets are ICMP Echo packets.

8. The method according to claim 1, wherein a remote agent, software or hardware generates a response to the one or more packets.

9. The method according to claim 1, wherein the predetermined network test is parameterized according to a desired resolution for generating one or more IP network characterizations at the desired resolution.

10. The method according to claim 1, wherein the predetermined network test is parameterized according to a desired resolution for generating one or more IP network characterizations at a resolution greater than the desired resolution.

11. The method according to claim 9, wherein each of the one or more network characterizations are selected from the group comprising one-way bitrate, one way propagation delay, one way delay variation, one way available bitrate and packet loss.

12. The method according to claim 11, wherein each of the one or more network characterizations is statistically evaluated thereby evaluating a maximum, minimum, mean and standard deviation thereof.

13. The method according to claim 1, wherein the predetermined network test comprises a command, said command including transmitting one or more packets and receiving one or more IP network responses thereto.

14. The method according to claim 13, wherein the predetermined network test comprises a task, said task including one or more commands.

15. The method according to claim 14, wherein the predetermined network test comprises a stage, said stage including one or more tasks.

16. The method according to claim 15, wherein the predetermined network test comprises a test, said test including one or more stages.

17. The method according to claim 16, wherein the predetermined network test comprises a suite, said suite including one or more tests.

18. The method according to, claim 13, wherein said command includes transmitting a single packet, said single packet characterized by one or more variables selected from the group comprising size, protocol, TTL and TOS.

19. The method according to claim 13, wherein said command includes transmitting a burst of packets.

20. The method according to claim 19, wherein said burst of packets comprises packets characterised by one or more variables selected form the group comprising size, protocol, TTL and TOS.

21. The method according to claim 13, wherein said command includes transmitting a stream of packets.

22. The method according to claim 13, wherein said predetermined test spans a specified period of time, thereby enabling evaluation of one or more IP network characterizations over time.

23. The method according to claim 22, wherein evaluation of one or more IP network characterizations over time includes evaluating a discontinuous change of one or more IP network characterizations.

24. The method according to claim 22, wherein evaluation of one or more IP network characterizations over time includes evaluating a rate of variation of the one or more IP network characterizations with respect to a threshold.

25. The method according to claim 24, wherein evaluation of one or more IP network characterizations over time includes evaluating a change in the rate of variation of the one or more IP network characterizations.

26. The method according to claim 15, wherein the predetermined test enables the evaluation of a test signature.

27. The method according to claim 17, wherein the predetermined test enables the evaluation of a temporal signature.

28. The method according to claim 1, wherein determining a subsequent network test comprises the steps of performing one or more threshold comparisons of the one or more critical indicators and determining the subsequent network test based on a decision tree correlating potential subsequent network tests with potential threshold comparison outcomes.

29. The method according to claim 1, wherein said method is repeated until a stop trigger is received.

30. An apparatus for automating and scaling active probing-based IP network performance monitoring and diagnostics of a network path between a first node and second node, said apparatus comprising:
a) an input for receiving a trigger initiating a predetermined network test having a predetermined resolution level;
b) a sampling mechanism for performing the predetermined network test, said predetermined network test including transmitting one or more IP packets between the first node and the second node and collecting information relating to transmission characteristics of the one or more IP packets; and
c) an analysis system for determining one or more critical indicators based on the transmission characteristics of the one or more IP packets, said analysis system further for evaluating the one or more critical indicators with a predetermined set of criteria associated with the predetermined resolution level and determining a subsequent network test based thereon, said subsequent network test having the predetermined resolution level or an alternate resolution level.

31. The apparatus according to claim 30, wherein the sampling system configures the one or more packets to generate one or more predetermined responses from the IP network.

32. The apparatus according to claim 31, wherein each of the one or more predetermined responses are selected from the group comprising ICMP Echo Reply packet, ICMP Timestamp Reply packet, ICMP Port Unreachable packet, ICMP TTL Expiry message, ICMP Fragmentation Required But DF Set message, TCP reset packet, UDP echo packet, ACK response and SYN response.

33. The apparatus according to claim 30, wherein the sampling system generates the one or more packets using ICMP, UDP or TCP.

34. The apparatus according to claim 33, wherein the sampling system generates the one or more packets as ICMP Echo packets.

35. The apparatus according to claim 30, wherein a remote agent, software or hardware generates a response to the one or more packets.

36. The apparatus according to claim 30, wherein the predetermined network test is parameterized according to a desired resolution for generating one or more IP network characterizations at the desired resolution.

37. The apparatus according to claim 30, wherein the predetermined network test is parameterized according to a desired resolution, for generating one or more IP network characterizations at a resolution greater than the desired resolution.

38. The apparatus according to claim 36, wherein each of the one or more network characterizations are selected from the group comprising one-way bitrate, one way propagation delay, one way delay variation, one way available bitrate and packet loss.

39. The apparatus according to claim 38, wherein each of the one or more network characterizations is statistically evaluated thereby evaluating a maximum, minimum, mean and standard deviation thereof.

40. The apparatus according to claim 30, wherein the predetermined network test comprises a command, said command including transmitting one or more packets and receiving one or more IP network responses thereto.

41. The apparatus according to claim 40, wherein the predetermined network test comprises a task, said task including one or more commands.

42. The apparatus according to claim 41, wherein the predetermined network test comprises a stage, said stage including one or more tasks.

43. The apparatus according to claim 42, wherein the predetermined network test comprises a test, said test including one or more stages.

44. The apparatus according to claim 43, wherein the predetermined network test comprises a suite, said suite including one or more tests.

45. The apparatus according to claim 40, wherein said command includes transmitting a single packet, said single packet characterized by one or more variables selected from the group comprising size, protocol, TTL and TOS.

46. The apparatus according to claim 40, wherein said command includes transmitting a burst of packets.

47. The apparatus according to claim 46, wherein said burst of packets comprises packets characterised by one or more variables selected form the group comprising size, protocol, TTL and TOS.

48. The apparatus according to claim 40, wherein said command includes transmitting a stream of packets.

49. The apparatus according to claim 40, wherein said predetermined test spans a specified period of time, thereby enabling evaluation of one or more IP network characterizations over time.

50. The apparatus according to claim 49, wherein evaluation of one or more IP network characterizations over time includes evaluating a discontinuous change of one or more IP network characterizations.

51. The apparatus according to claim 49, wherein evaluation of one or more IP network characterizations over time includes evaluating a rate of variation of the one or more IP network characterizations with respect to a threshold.

52. The apparatus according to claim 51, wherein evaluation of one or more IP network characterizations over time includes evaluating a change in the rate of variation of the one or more IP network characterizations.

53. The apparatus according to claim 42, wherein the predetermined test enables the evaluation of a test signature.

54. The apparatus according to claim 44, wherein the predetermined test enables the evaluation of a temporal signature.

55. A computer program product comprising a computer readable medium carrying a set of computer-readable signals including instructions which, when executed by a computer processor, cause the computer processor to execute a method for automating and scaling active probing-based IP network performance monitoring and diagnostics of a network path between a first node and second node, said method comprising the steps of:
a) receiving a trigger initiating a predetermined network test having a predetermined resolution level;
b) performing the predetermined network test, said predetermined network test including transmitting one or more IP packets between the first node and the second node and collecting information relating to transmission characteristics of the one or more IP packets;
c) determining one or more critical indicators based on the transmission characteristics of the one or more IP packets;
d) evaluating the one or more critical indicators with a predetermined set of criteria associated with the predetermined resolution level and determining a subsequent network test based thereon, said subsequent network test having the predetermined resolution level or an alternate resolution level; and
e) performing the subsequent network test.
